(19) United States
(12) Patent Application Publication
(10) Pub. No.: US 2015/0343314 A1
(43) Pub. Date: Dec. 3, 2015

(54) GAME AND METHOD FOR PLAYING THE GAME

(71) Applicant: Tradeplayer Limited, Edinburgh (GB)

(72) Inventor: Killian Jones, London (GB)

(73) Assignee: Tradeplayer Limited, Edinburgh (GB)

(21) Appl. No.: 14/290,686

(22) Filed: May 29, 2014

(51) Int. Cl. A63F 13/795; A63F 13/812; A63F 13/847; A63F 13/46

(52) U.S. Cl. CPC A63F 13/795; A63F 13/46; A63F 13/812; A63F 13/847

(57) ABSTRACT

A computer-implemented method for playing a game is disclosed. In the game, each of a plurality of participants defines one or more sets of entities, each of which is associated with the participant that defines it, by selecting entities from a predefined list, each entity in the predefined list corresponding to an actual entity. A score is awarded to each participant based on the performance of the actual entities corresponding to entities in a set of entities associated with and selected by each participant. The method comprises:
a) providing data defining one or more sets of entities associated with participants other than the first participant, to enable the one or more sets of entities to be presented to a first participant of the plurality of participants;
b) receiving, from the first participant, user input selecting a desired one of the sets of entities associated with participants other than the first participant; and
c) awarding a score to the first participant based on the performance of actual entities corresponding to entities in the desired set of entities selected by the first participant; wherein the providing, the receiving, and the awarding are performed by at least one system comprising a programmable processor.

A system and a computer program product for carrying out the method are also disclosed.

### TECHNICAL FIELD

The subject-matter described herein relates to a computer-implemented method for playing a game, in which each of a plurality of participants defines one or more sets of entities, each of which is associated with the participant that defines it, by selecting entities from a predefined list, each entity in the predefined list corresponding to an actual entity, and in which a score is awarded to each participant based on the performance of the actual entities corresponding to entities in a set of entities associated with and selected by each participant.

It also relates to a system and to a computer program product for carrying out the method.

### BACKGROUND

Fantasy sports games are widely known and enjoyed by many. A typical example is fantasy soccer, in which participants select a team of players from a list of available soccer players to constitute a fantasy team. Each player has an associated value and each participant is typically allowed to spend a predefined budget in selecting their team. The participants' teams are awarded points based on the performance of the actual players corresponding to the selected team members in real matches. The aim of the game is to pick a team of players for the predefined budget amount that will return a higher score than other participants' teams. The winning participant is the one with the highest score after the relevant matches have been played. These types of games may be played simply for enjoyment or may involve the placing of cash stakes by the participants, with higher-scoring participants receiving a greater return of the total stakes.

### SUMMARY

In one aspect of this disclosure, there is a computer-implemented method for playing a game, in which each of a plurality of participants defines one or more sets of entities, each of which is associated with the participant that defines it, by selecting entities from a predefined list, each entity in the predefined list corresponding to an actual entity, and in which a score is awarded to each participant based on the performance of the actual entities corresponding to entities in a set of entities associated with and selected by each participant. The method comprises:

a) providing data defining one or more sets of entities associated with participants other than the first participant, to enable the one or more sets of entities to be presented to a first participant of the plurality of participants;
b) receiving, from the first participant, user input selecting a desired one of the sets of entities associated with participants other than the first participant; and
c) awarding a score to the first participant based on the performance of actual entities corresponding to entities in the desired set of entities selected by the first participant; wherein the providing, the receiving, and the awarding are performed by at least one system comprising a programmable processor.

The method is typically computer-implemented, in which case the method is carried out by one or more processors.

The data defining one or more sets of entities associated with participants other than the first participant may be provided by a server and the one or more sets of entities may be presented to the first participant at a client device, such as a smartphone, tablet, laptop or PC.

The score awarded to each participant may be an aggregate score for each team with which they are associated or a score may be awarded in respect of each team with which they are associated individually.

The one or more sets of entities associated with participants other than the first participant presented to the first participant may exclude sets of entities associated with the first participant. Alternatively, it may include sets of entities associated with the first participant.

The performance of the actual entities may be determined from a data feed indicating achievements of the actual entities. For example, if the actual entities are soccer players, the data feed may indicate the scoring of goals by the actual entities, amongst other things.

Each of the actual entities may be a sportsperson, such as a soccer player. In this case, the sets of entities selected by participants will represent fantasy teams of soccer players. In other embodiments, the actual entities may have no relationship to sports at all. For example, the actual entities may be publically-traded company shares, in which case the performance might be based on the share price and/or other factors generally related to share performance such as measures of volatility and price-to-earnings ratio.

In one embodiment, participants may be inhibited from defining sets of entities after expiry of a selection deadline. For example, the selection deadline may be a predefined period of time prior to commencement of a set of actual events involving the actual entities. By way of example, soccer matches are often played at the weekend; the selection deadline could therefore be set at midnight on a Saturday before the commencement of a series of soccer matches.

Presenting, to the first participant, of the one or more sets of entities associated with participants other than the first participant may occur only after the start of a presentation period. The presenting may occur in response to selection by the first participant of an option on a user interface.

Presenting, to the first participant, of the one or more sets of entities associated with participants other than the first participant may involve presenting only names of the sets of entities prior to the start of a presentation period. For example, when the sets of entities represent fantasy soccer teams, the names of the teams only may be presented prior to the start of the presentation period. The names of the teams may be names allocated by the associated participant or may be based on the username or real name of the associated participant, in which case they will usually be computer generated.

Presenting, to the first participant, of the one or more sets of entities associated with participants other than the first participant may involve presenting the entities in each of the sets of entities after the start of a presentation period. In this case, only names of the sets of entities may be presented prior to the start of the presentation period and both the names of the sets of entities and the entities may be presented after the start of the presentation period.

The start of the presentation period may occur at the same time as the expiry of the selection deadline.

In one embodiment, a set of entities associated with a participant other than the first participant may be presented to the first participant only if the participant other than the first participant has asserted an opt-in flag associated with the set of entities.

Alternatively or in addition, a set of entities associated with a participant other than the first participant may not be presented to the first participant if the participant other than the first participant has asserted an opt-out flag associated with the set of entities.

Presenting, to the first participant, of the one or more sets of entities associated with participants other than the first participant may involve presenting only those sets of entities which comply with one or more filtering characteristics specified by the first participant. Possible filtering characteristics that may be specified include characteristics that result in filtering to: only sets of entities including a specified entity being presented; only sets of entities that do not include a specified entity being presented; and only sets of entities that include a defined number (or less than or more than or at least the defined number) of entities that are associated with an actual group of entities (for example, an actual soccer team).

Other possible filtering characteristics include filtering to: only sets of entities having a total number of points that exceeds a specified threshold; only sets of entities having a points-per-entity value that exceeds a specified threshold; and only sets of entities including entities for whom an available activity time exceeds a specified threshold. The threshold(s) may be specified by the first participant. The available playing time allows filtering to include only sets of entities, which can be expected to engage in enough activity to result in the accumulation of a meaningful number of points (for example, in the case of soccer players have enough playing time available to score goals or make other achievements).

Awarding a score to the first participant may entitle the first participant and/or the participant associated with the selected one of the sets of entities to a prize. There are a variety of options for allocation of an available prize fund. For example, the first participant may be allocated a share of the available prize fund. Similarly, the participant associated with the selected one of the sets of entities may also be allocated a share of the available prize fund. The allocated shares may be predetermined by a game organizer. Alternatively, they may be predetermined by the participant associated with the selected one of the sets of entities or by agreement between the participant associated with the selected one of the sets of entities and the first participant.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages.

The details of one or more variations of the subject-matter described herein are set forth in the accompanying drawings and the description below. Other features and advantages of the subject matter described herein will be apparent from the description and drawings, and from the claims.

### DESCRIPTION OF DRAWINGS

FIG. 1 shows a flowchart of a method according to an embodiment of the invention; and

FIG. 2 shows a computer system suitable for implementing the method illustrated by FIG. 1.

Like reference symbols in the various drawings indicate like elements.

### DETAILED DESCRIPTION

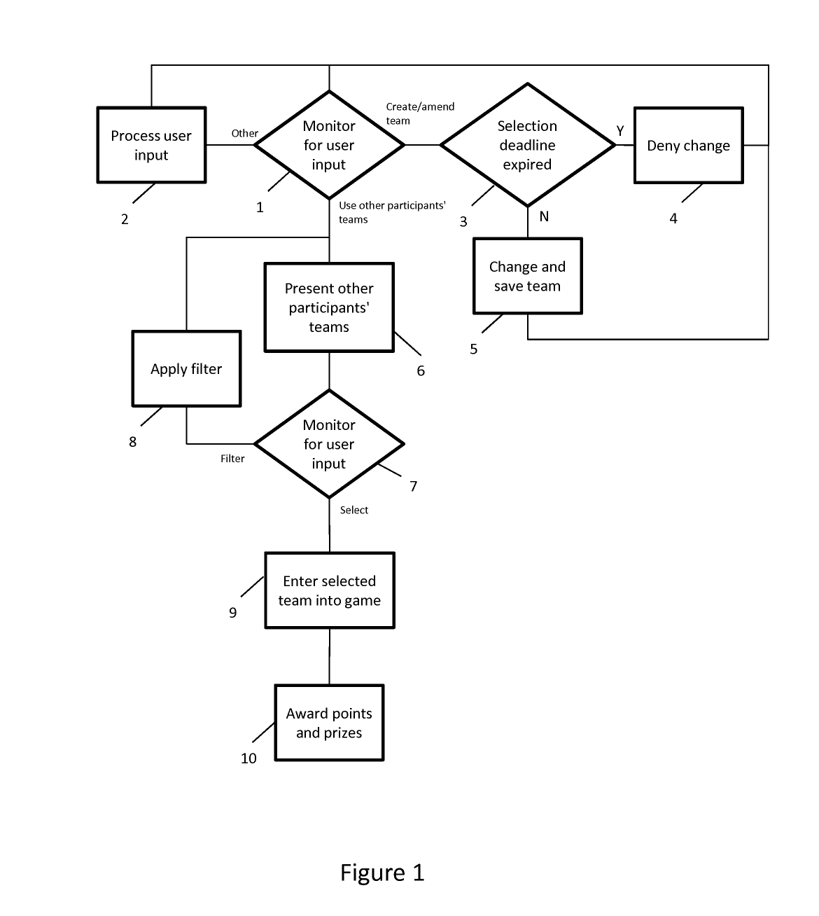

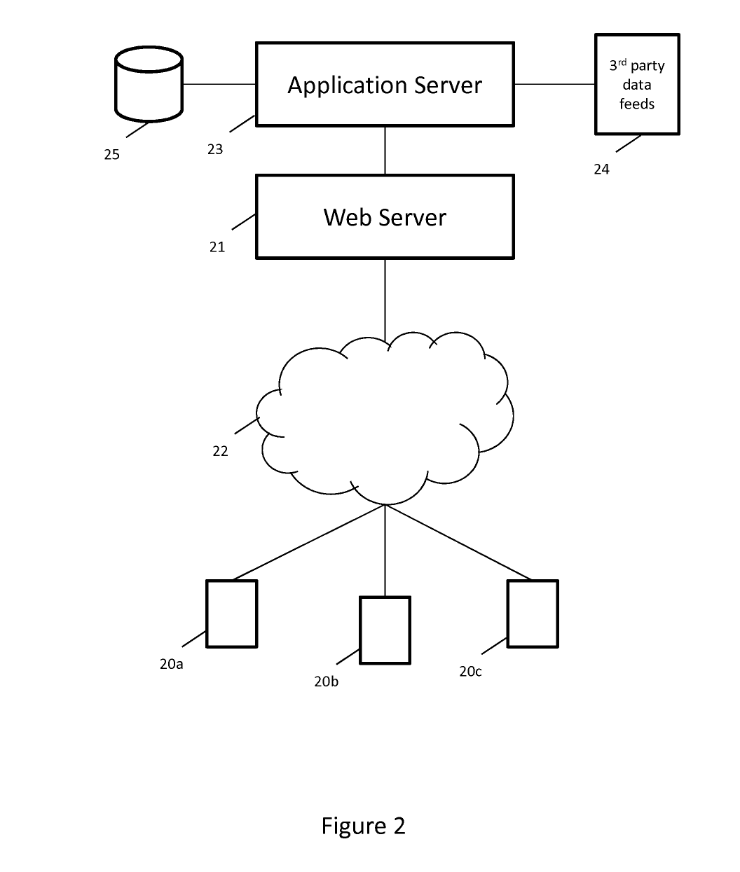

FIGS. 1 and 2 relate to an embodiment of the invention relating to a fantasy soccer game. Participants in the game make use of the Internet to gain access to a central server running application software for allowing the game to be played. This will be described in detail below.

Each participant in the game is allowed to select one or more teams of players from a list of all players in a soccer league or from a list of all players that will be playing in a relevant period of time (for example, at the following weekend). Other embodiments may relate to other sports or sports league. Each player available for selection is assigned a value by the game organizer or using a predefined algorithm. The value may change from time-to-time.

Each participant in the game has a fixed budget allocated by the application software to spend on their team of a set number of players. Participants are able to enter either a single team or multiple teams. They can amend their team or teams as many times as they wish until expiry of a selection deadline. In this embodiment relating to fantasy soccer, for example, participants may be selecting teams of players representing actual players that will be playing in matches over a day, weekend or other relevant period. The selection deadline may therefore occur, for example, at midnight on a Saturday prior to the start of the relevant matches.

After the selection deadline passes, teams are locked in their final state and no more amendments can occur. Before the deadline passes, participants cannot see other participant's teams. After the deadline passes, the constitution of all teams is available to view by all participants.

Participants can select to enter any number of their selected teams into one-on-one and/or multiplayer games. A one-on-one game is where two participants each enter a team into a game against one another. Each player may pay a fee for entering the game, each player's fee covering a commission for the game organizer and a contribution to a prize fund. The team that scores the most points wins 100% of the prize fund.

A multiplayer game is where more than two participants each enter one or more teams into a game. The participant(s) with the team(s) that score the highest points wins the prize fund or their share of the prize fund, depending on the payout structure of the relevant game. The payout structure of the game may be one of the following: the participant with the top scoring team wins 100% of the prize fund, similar to a One-on-One payout structure; 50% of the prize fund goes to the participant with the highest score, 30% of the prize fund goes to the participant with the second highest score, and 20% of the prize fund goes to the participant with the third highest score; participants associated with the highest scoring 50% of teams win double their contribution to the prize fund; or participants associated with the highest third of teams win treble their contribution to the prize fund. In another variant, the percentage of the prize fund awarded to a participant depends on the number of teams entered into the multiplayer game.

Data relating to the matches on which the game is based is received from one or more third party data suppliers. For example, the data may be data received as the matches are played. Points are accumulated by participants as the actual players corresponding to those that they have selected in their teams make various achievements, for example the scoring of goals, in the actual matches. The actual achievements will of course depend on the activity or sport in question. Other achievements, particularly in the case of soccer, might include saves by a goalkeeper, clearance of the ball, tackles, interceptions and assists. Some achievements might result in a negative number of points, for example, conceding a goal or receiving a red or yellow card from the referee.

Scores awarded to participants' teams that have been entered in one-on-one and multiplayer games are continuously updated based on the information about the actual matches and the actual players' performance received in the data feeds. Once all the relevant matches are completed, the teams are in their final finishing positions, and prizes are awarded to the participants with the top scoring team(s). The player values can then be updated, taking into account the latest set of player performance data from the data feed, and participants can select team(s) for the next set of matches.

Although teams become locked from further editing or selection once the selection deadline passes, participants can continue to enter teams into one-on-one and multiplayer games but before the relevant matches are finished. This enables participants to continue entering teams into games as the actual matches are unfolding and real-time data is being received. This enhances the participants' experience by enabling them to enter games with more information than they had before the selection deadline expires.

Thus, in the game described above each of a plurality of participants may define one or more associated sets of entities (referred to above as teams of players) by selecting entities (referred to above as players) from a predefined list, each entity in the predefined list corresponding to an actual entity (referred to above as actual players). A score is awarded to each participant based on the performance of the actual entities corresponding to entities in one or more of the sets of entities associated with and selected by the participant.

The above description of this embodiment provides some context for the playing of the game. Representative and illustrative features of this embodiment are explained with reference to FIG. 1.

In FIG. 1, processing starts at 1, where the software application for implementing the game waits for user input. For the sake of simplicity, FIG. 1 categorizes all user input other than selection of the option to create or amend teams (“Create/amend teams” in FIG. 1) and to use other participants' teams (“Use other participants' teams” in FIG. 1) as “Other”. If the user input falls into the “Other” category, it is processed at 2 before processing reverts to 1.

If a participant selects the option at 1 to create or amend a team, the software application checks at 3 whether the selection deadline has passed. If it has, the request to amend or create a team is denied at 4. If it has not passed then further user input is gathered at 5 to define the new team or to define the amendments required to a previously defined team, and these are saved to a database storing details of the teams.

If a first participant selects the option at 1 to use other participants' teams then the software application transmits a list of teams that are associated with other participants and are available for selection by the first participant at 6 to a client device in the possession of the first participant. The transmitted list of teams is displayed to the first participant on the client device. For example, at 6 all other teams associated with participants other than the first participant may initially be revealed. In the more general sense, the first participant is therefore presented at 6 with sets of entities associated with participants other than the first participant.

In some embodiments, the teams of other participants may only be transmitted for presenting to the first participant at 6 after expiry of the selection deadline. In this case, if the selection deadline has not passed then a notice may be displayed to the first user at 6 indicating that this option is not yet available. In other embodiments, the option to select other participants' teams may not be displayed until the selection deadline has passed.

Alternatively, in other embodiments, only the names of the teams of other participants available for selection may be transmitted for presentation to the first participant if the selection deadline has not passed. Selection of one of these teams by name will not reveal the players that constitute the team if the selection deadline has not yet passed. On the other hand, if the selection deadline has passed then selection of the team may result in the players being presented to the first participant.

The list of teams associated with participants other than the first participant that is transmitted for presenting to the first participant at 6 may depend on opt-in and/or opt-out flags associated with each team. For example, if a participant selects the opt-out flag when defining a team then that team would not be transmitted for presentation to the first participant at 6. In another example, a team would only be transmitted for presentation to the first participant at 6 if the opt-in flag had been selected by the participant who defined the team.

Monitoring for further user input from the first participant occurs at 7, which at this stage can be to select a team from the list transmitted for presentation at 6 or to filter the list of teams. If the option to filter the list of teams is selected then filter characteristics are gathered from the first participant at 8 and applied to the list of teams, which is updated at 6. Thus, only those teams that comply with the filter characteristics will be presented to the first participant. Filtering that may be applied includes: filtering to include only sets of entities (in this embodiment, teams) that contain an entity (in this embodiment, a player) specified in the filter characteristics; filtering to exclude sets of entities (in this embodiment, teams) that contain an entity (in this embodiment, a player) specified in the filter characteristics; and filtering to include only sets of entities (in this embodiment, teams) that include at least a specified number of entities (in this embodiment, players) that are associated with a group of entities (in this embodiment, actual teams of players).

As explained above, other possible filtering that may be applied includes filtering to include: only teams having a total number of points that exceeds a threshold specified by the first participant; only teams having a points-per-player value that exceeds a threshold specified by the first participant; and only teams including players for whom an available playing time exceeds a threshold specified by the first participant.

If a participant finds a team that they wish to use from the list transmitted for presentation at 6 then they may select it at 7 and enter the selected team into a one-on-one or multiplayer game at 9. The first participant may do this with as many teams associated with other participants as they wish.

At 10, a score is then awarded to the first participant based on his selection of the other participant's team. As described above the score is continuously updated based on the information about the actual matches and the actual players' performance received in the data feeds. The awarded score may entitle the first participant to a share of a prize fund as already described above. The first participant may receive the benefit of any points already scored by the other participant's team that he has selected before the first participant entered the team into a game. Alternatively, the first participant may only receive the benefit of points accrued after he has entered the team into a game.

The other participant associated with the team selected by the first participant (i.e. the participant who originally created the team) may also receive a prize as a result of the score achieved by the first participant using the team. The prize may be a share of the overall prize fund earned from the game involving the team. The share may be determined by a third party company operating the application; by the other participant; or by agreement between the other participant and the first participant. In some embodiments, the other participant may adjust the share they desire at any point before the first participant has selected the team for entry into a game. This allows the other participant to take account of particularly favourable developments in an actual game, which might make their team desirable to select, as they occur.

FIG. 2 shows a computer system suitable for implementing the embodiment described above. In this, a number of client devices 20a, 20b, 20c are able to access a web server 21 over the Internet 22. The client devices 20a, 20b, 20c may be smartphones, tablets, laptops, desktop computers, smart televisions or any other computing device capable of receiving and rendering web content over the Internet.

The web server 21 receives requests for web content from the client devices 20a, 20b, 20c and communicates these, as appropriate, to an application server 23. The requests received from the client devices 20a, 20b, 20c may include details of user input from participants. The application server 23 runs software that carries out the method described above and with reference to FIG. 2. It returns data, such as the list of teams associated with participants other than the first participant, to the web server, which transmits suitable hypertext markup language (HTML) content to the client devices 20a, 20b, 20c for rendering on the device. The application server 23 comprises one or more processors coupled to a memory, which can store instructions that when executed carry out the above-described method. Typically, these instructions will be stored as one or more computer programs on a tangible, non-volatile, computer-readable medium (such as a hard drive) for loading into the memory as required.

The application server 23 is also configured to receive the data feeds described above from third party sources 24. Typically, the data will be received over the Internet. It is also connected to a database server 25, which stores and allows retrieval of data related to participants (e.g. name and address details, financial information such as prize winnings), details of players available for selection, details of teams defined by participants and other data that may be required for the application server 23 to store permanently.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method for playing a game, in which each of a plurality of participants defines one or more sets of entities, each of which is associated with the participant that defines it, by selecting entities from a predefined list, each entity in the predefined list corresponding to an actual entity, and in which a score is awarded to each participant based on the performance of the actual entities corresponding to entities in a set of entities associated with and selected by each participant, the method comprising:
a) providing data defining one or more sets of entities associated with participants other than the first participant, to enable the one or more sets of entities to be presented to a first participant of the plurality of participants;
b) receiving, from the first participant, user input selecting a desired one of the sets of entities associated with participants other than the first participant; and
c) awarding a score to the first participant based on the performance of actual entities corresponding to entities in the desired set of entities selected by the first participant; wherein the providing, the receiving, and the awarding are performed by at least one system comprising a programmable processor.

2. A method according to claim 1, wherein each of the actual entities is a sportsperson.

3. A method according to claim 2, wherein the sportsperson is a soccer player.

4. A method according to claim 1, wherein the participants are inhibited from defining sets of entities after expiry of a selection deadline.

5. A method according to claim 1, wherein presenting, to the first participant, of the one or more sets of entities associated with participants other than the first participant occurs only after the start of a presentation period.

6. A method according to claim 1, wherein presenting, to the first participant, of the one or more sets of entities associated with participants other than the first participant comprises presenting only names of the sets of entities prior to the start of a presentation period.

7. A method according to claim 1, wherein presenting, to the first participant, of the one or more sets of entities associated with participants other than the first participant comprises presenting the entities in each of the sets of entities after the start of a presentation period.

8. A method according to claim 1, wherein a set of entities associated with a participant other than the first participant is presented to the first participant only if the participant other than the first participant has asserted an opt-in flag associated with the set of entities.

9. A method according to claim 1, wherein a set of entities associated with a participant other than the first participant is not presented to the first participant if the participant other than the first participant has asserted an opt-out flag associated with the set of entities.

10. A method according to claim 1, wherein presenting, to the first participant, of the one or more sets of entities associated with participants other than the first participant comprises presenting only those sets of entities which comply with one or more filtering characteristics specified by the first participant.

11. A method according to claim 1, wherein awarding a score to the first participant entitles the first participant and/or the participant associated with the selected one of the sets of entities to a prize.

12. A method according to claim 11, wherein the first participant is allocated a share of an available prize fund.

13. A method according to claim 12, wherein the allocated share is predetermined by a game organizer, predetermined by the participant associated with the selected one of the sets of entities, or predetermined by agreement between the participant associated with the selected one of the sets of entities and the first participant.

14. A method according to claim 11, wherein the participant associated with the selected one of the sets of entities is allocated a share of an available prize fund.

15. A method according to claim 14, wherein the allocated share is predetermined by a game organizer, predetermined by the participant associated with the selected one of the sets of entities, or predetermined by agreement between the participant associated with the selected one of the sets of entities and the first participant.

16. A system comprising one or more processors and a memory coupled to the one or more processors, wherein the memory stores instructions executable by the or each processor that cause the system, on execution of the instructions, to carry out a method for playing a game, in which each of a plurality of participants defines one or more sets of entities, each of which is associated with the participant that defines it, by selecting entities from a predefined list, each entity in the predefined list corresponding to an actual entity, and in which a score is awarded to each participant based on the performance of the actual entities corresponding to entities in a set of entities associated with and selected by each participant, wherein execution of the instructions stored in the memory additionally causes the system to:
a) provide data defining one or more sets of entities associated with participants other than the first participant, to enable the one or more sets of entities to be presented to a first participant of the plurality of participants;
b) receive, from the first participant, user input selecting a desired one of the sets of entities associated with participants other than the first participant; and
c) award a score to the first participant based on the performance of actual entities corresponding to entities in the desired set of entities selected by the first participant.

17. A computer program product comprising a computer-readable medium on which a set of instructions is stored, the instructions being configured, on execution by one or more processors, to carry out a method for playing a game, in which each of a plurality of participants defines one or more sets of entities, each of which is associated with the participant that defines it, by selecting entities from a predefined list, each entity in the predefined list corresponding to an actual entity, and in which a score is awarded to each participant based on the performance of the actual entities corresponding to entities in a set of entities associated with and selected by each participant, the method comprising:
a) providing data defining one or more sets of entities associated with participants other than the first participant, to enable the one or more sets of entities to be presented to a first participant of the plurality of participants;
b) receiving, from the first participant, user input selecting a desired one of the sets of entities associated with participants other than the first participant; and
c) awarding a score to the first participant based on the performance of actual entities corresponding to entities in the desired set of entities selected by the first participant.
